(19) United States
(12) Patent Application Publication
(10) Pub. No.: US 2008/0050212 A1
(43) Pub. Date: Feb. 28, 2008

(54) Motorcycle hauling stabilizer

(76) Inventor: Stephen E. Ormsby, S. Beach, OR (US)

Correspondence Address: Carl D. Crowell, P.O. Box 923, Salem, OR, 97308, US

(21) Appl. No.: 11/510,082

(22) Filed: Aug. 25, 2006

(51) Int. Cl. B62D 43/00

(52) U.S. Cl. 414/463

(57) ABSTRACT

A motorcycle hauling stabilizer for transporting motorcycles in a pickup truck bed. A flange on the motorcycle hauling stabilizer wraps snugly over the top of a truck bed wall. The flange secures the motorcycle hauling stabilizer in the truck bed and reinforces the bed wall, preventing the bed wall from bending when a motorcycle is strapped in. A motorcycle is secured for transport by pushing its front wheel between two wheel stabilizers which keep the front wheel and thus the rest of the motorcycle upright. The motorcycle hauling stabilizer preserves a truck bed's cargo area because it protrudes only slightly in to the truck bed. Thus, it does not need to be removed when not in use.

### BACKGROUND

This invention relates to a motorcycle stabilizer for transporting motorcycles, specifically to, a motorcycle hauling stabilizer for securing motorcycles in the bed of a pickup truck so the motorcycle may be transported safely and easily.

Motorcycles are vehicles in themselves and thus can be moved simply by riding them to a desired location. However, motorcyclists often find it convenient or even necessary to transport their motorcycles without having to ride them. This can be seen in the case where there is one rider and more than one motorcycle or where a motorcycle, such as a motocross bike, should not be ridden on surface roads.

Of the vehicles large enough to carry a motorcycle, a pickup truck is most commonly used in transporting motorcycles. A motorcycle can be placed on its side in the bed of a pickup truck and be transported without any additional stabilizing or securing. However, during transport the motorcycle is free to slide about the bed. Furthermore, sideways, a motorcycle occupies much of the truck's bed making it difficult or impossible to place additional cargo in the bed.

Thus, various devices have been devised to secure motorcycles upright to pickup truck beds. U.S. Pat. No. 3,912,139 discloses a removable vehicle mounted cycle carrier utilizing a horizontally oriented channel long enough to support both cycle wheels. A slot in the bottom of the channel receives the front wheel and secures the wheel between the channel walls. The channel is secured to a pickup truck bed by extendable bars which extend perpendicularly from the channel and engage the side walls of the truck bed. This secures a cycle upright in the truck bed however, a substantial portion of the bed is covered by the cycle carrier which reduces available cargo space. When no cycle is being transported the carrier must be removed to reclaim lost cargo space.

U.S. Pat. No. 5,836,490 discloses a truck bed bicycle rack utilizing an elongated rod secured parallel to a truck bed. Two adjustable wheel bails slide along the rod to accommodate the wheels of a bicycle. The bails are of sufficient size to allow the bicycle wheels to sink into them. In this way, the bails can support a bicycle. This rack, with its single rod design, uses substantially less cargo area than the above device. However, the single rod design is not robust enough to securely support motorcycles because motorcycles are much heavier than bicycles. Also, because the wheels must be dropped into the wheel bails, installation into this device requires the bicycle or motorcycle to be lifted into the rack.

U.S. Pat. No. 5,516,020 discloses a truck mount bicycle rack utilizing a set of tubes arranged in a square. Vertical tubes are attached within the square to form slots for bicycle wheels. The rack is secured at an angle using removable straps. A bicycle is supported by inserting its front wheels between the vertical slots. In this rack, the truck bed carries the weight of the bicycle. This rack could possibly secure motorcycles because the truck bed is carrying the weight. However, its cargo space usage is relatively large because it is installed at an angle. Thus, it must be removed when not in use to maximize cargo capacity. Furthermore, the use of straps to secure the rack may allow unwanted motion during transport, especially over uneven terrain.

There are also products like the “Bed Buddy Pro LT” and the “Samson Bed Rack” which comprise a metal bar with triangular wheel stabilizers. The metal bar is attached to the truck bed wall immediately behind the truck's passenger compartment. The triangular wheel stabilizers face outward and are spaced to receive and hold the front wheel of a motorcycle. The motorcycle is then secured by strapping the motorcycle, typically by its handlebars, to hooks on the metal bar. As the straps are tightened the wheel stabilizers securely support the motorcycle vertically while the truck bed carries the motorcycles weight. These products use virtually no cargo space because the metal bar and triangular wheel stabilizers protrude, at most, a few inches into the bed. In addition, these products are easy to use because a motorcycle can simply be pushed up a ramp, onto the truck bed, and into the wheel stabilizer. However, these products have a complex installation process requiring precise measurements and drilling for attachment screws. Furthermore, where the metal bar is of insufficient rigidity, the metal bar and the bed wall it is attached to have been known to bend when the straps used to tie down a motorcycle are tightened.

What is desired and herein disclosed is a motorcycle hauling stabilizer for use in a pickup truck bed that can be easily installed and having sufficient rigidity to prevent bending while being so unobtrusive that it can remain installed without reducing the cargo area of the truck bed. The motorcycle hauling stabilizer has appropriately spaced wheel stabilizers which receive and secure the front wheel of a motorcycle and allow a motorcycle to be easily installed by simply pushing it into the wheel stabilizer and tying it down. The motorcycle hauling stabilizer is designed to wrap over a truck bed wall and extend the full length of the bed wall. This prevents the motorcycle hauling stabilizer and bed wall from bending and allows for easily installation of the motorcycle hauling stabilizer into a truck bed.

### SUMMARY OF THE INVENTION

The subject of this invention is a motorcycle hauling stabilizer having one or more pairs of vertical wheel stabilizers which receive and secure the front wheel of a motorcycle. The motorcycle hauling stabilizer has a flange to wrap over a truck bed wall and continues down the entire vertical length of the bed wall. The wrap over design allows the motorcycle stabilizer to be easily installed by slipping it over the bed wall. This eliminates the complex measuring and attachment schemes in other devices. A series of hooks, arranged horizontally, give tie down straps a convenient place to attach to the motorcycle hauling stabilizer. The motorcycle hauling stabilizer hardly extends into the truck bed which preserves the available space in the truck bed for other cargo.

This invention addresses the issue of bending damage to the bed wall caused by the tightening of tie down straps. The wrap over design provides sufficient reinforcement to the bed wall to prevent the bed wall from bending when tie down straps are tightened. Lastly, this invention provides utility through ease of use not only because it does not have to be removed when not in use, but also because a motorcycle can be made ready for transport simply by pushing its front wheel into the wheel stabilizer and tying it down.

### BRIEF DESCRIPTION OF THE DRAWINGS

FIG. 1 is a perspective view of the motorcycle hauling stabilizer installed in a pickup truck bed.

FIG. 2 is a plan view of the motorcycle hauling stabilizer.

FIG. 3 is a side view of the motorcycle hauling stabilizer.

FIG. 4 is a perspective view of a pair of wheel stabilizers.

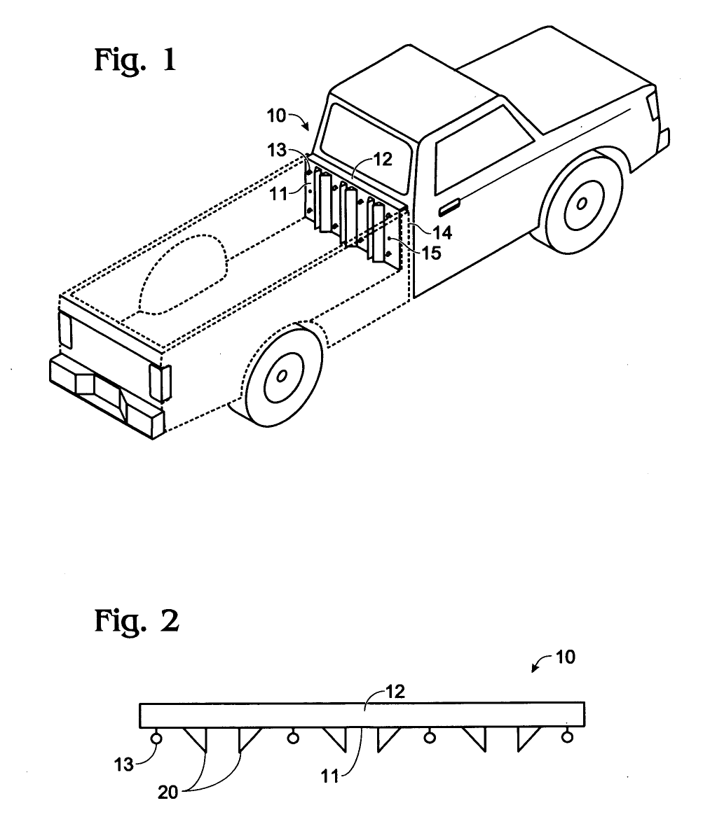

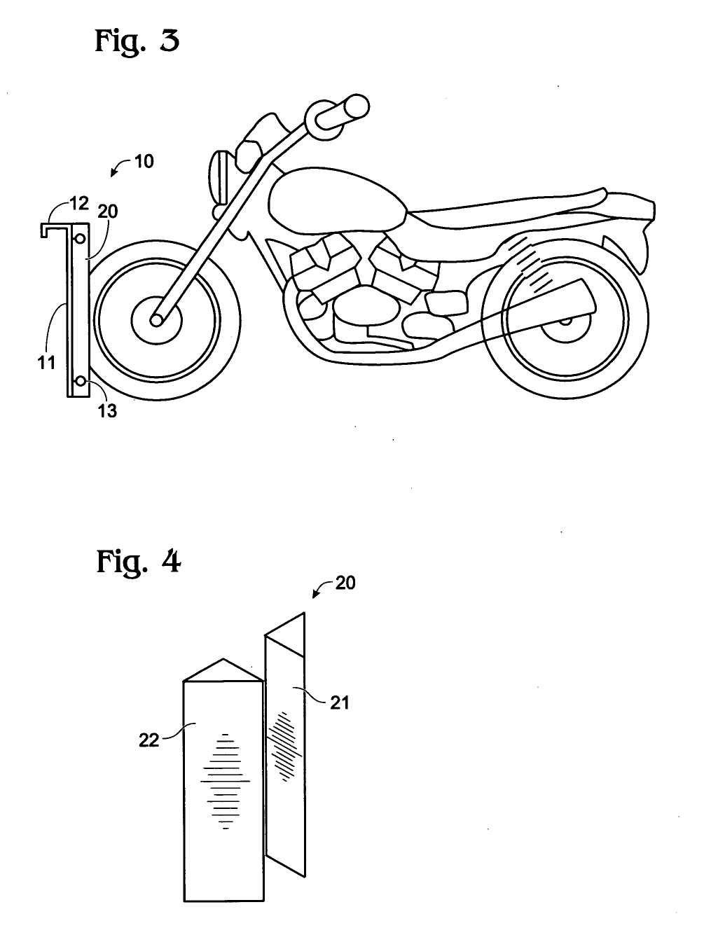

### PREFERRED EMBODIMENT OF THE INVENTION

In the preferred embodiment the motorcycle hauling stabilizer 10 is made of a planar rigid material such as sheet metal. The motorcycle hauling stabilizer 10 has a width less than the width of the pickup truck bed wall 14 immediately behind the passenger compartment of a pickup truck. The motorcycle hauling stabilizer 10 has a flange 12 which wraps over the bed wall 14 and a vertical face 1 1 which extends to substantially cover the vertical length of the bed wall 14. The flange 12 is formed such that it forms a “C” shaped channel that snugly fits over the top of the bed wall 14.

A plurality of hooks 13 and wheel stabilizers 20 are attached to the vertical face 11 of the motorcycle hauling stabilizer 10. The hooks 13 are arranged horizontally across the vertical face 11 and have holes to allow convenient and secure attachment points for tie down straps. The wheel stabilizers 20 are elongated structures and function in pairs spaced to allow the front wheel of a motorcycle to fit between them. The spacing is wide enough that the front wheel easily fits between two wheel stabilizers 20 but narrow enough hold the front wheel and consequently the motorcycle substantially upright.

The wheel stabilizers 20 extend into a pickup truck's bed from the vertical face 11. Each wheel stabilizer 20 has an inner face 21 and an outer face 22. In the preferred embodiment, each pair of wheel stabilizers 20 is arranged so their inner faces 21 are vertical and facing each other. The inner faces 21 extend in a substantially perpendicular orientation from the vertical face 11 and are substantially parallel to each other. When in use, the front wheel of a motorcycle is held between the two inner faces 21 of a particular pair of wheel stabilizers 20.

The motorcycle hauling stabilizer 10 is installed by lifting its flange 12 over the bed wall 14 and then lowering the flange 12 so that the top of the bed wall 14 enters the flange 12. Preferably, once this is done a plurality of screws are screwed into the bed wall through a series of holes 15 on the vertical face 11 to further secure the motorcycle hauling stabilizer 10 to the bed wall 14.

A motorcycle is secured to the motorcycle hauling stabilizer 10 first by getting the motorcycle onto the truck bed with the motorcycle's front wheel facing the motorcycle hauling stabilizer 10. Then, the motorcycle is pushed forward making sure that the front wheel is between a pair of wheel stabilizers 20. The motorcycle is pushed forward until the front wheel contacts the vertical face 11. Next, the motorcycle is tied to the hooks 13 on the motorcycle hauling stabilizer 10. Once the straps are tightened the motorcycle is secured and ready to be transported.

In an alternative embodiment, the motorcycle hauling stabilizer 10 is made of diamond plate sheet metal formed into a snug fitting flange 12 and a vertical face 11. In this embodiment the wheel stabilizers 20 are also made of diamond plate steel.

I claim:

1. A motorcycle hauling stabilizer comprising:
a) a flange;
b) a vertical face;
c) a plurality of hooks; and
d) a plurality of wheel stabilizers;
e) wherein said hooks and said wheel stabilizers are attached to said vertical face.

2. The motorcycle hauling stabilizer of claim 1 wherein said wheel stabilizers have a length substantially equal to the length of said vertical face.

3. The motorcycle hauling stabilizer of claim 2 wherein said vertical face has a length substantially equal to the vertical length of a truck bed wall.

4. The motorcycle hauling stabilizer of claim 3 wherein said wheel stabilizers are comprised of:
a) an outer surface; and
b) an inner surface;
c) wherein said inner surface is substantially perpendicular to said vertical face.

5. The motorcycle hauling stabilizer of claim 4 wherein pairs of said wheel stabilizers are spaced such that the distance between said pair of wheel stabilizers' said inner faces is greater than the width of a motorcycle wheel.

6. The motorcycle hauling stabilizer of claim 5 wherein said flange is sized to closely fit over the top of a truck bed wall.

7. The motorcycle hauling stabilizer of claim 6 wherein said hooks are arranged in a substantially horizontal linear arrangement across the width of said vertical face.

8. The motorcycle hauling stabilizer of claim 7 further comprising a plurality of holes in said vertical face for attachment screws.

9. The motorcycle hauling stabilizer of claim 8 wherein said flange, said vertical face, and said wheel stabilizers are made of sheet metal.

10. The motorcycle hauling stabilizer of claim 8 wherein said flange, said vertical face, and said wheel stabilizers are made of diamond plate sheet metal.
